(19) United States
(12) Patent Application Publication
(10) Pub. No.: US 2003/0146706 A1
(43) Pub. Date: Aug. 7, 2003

(54) Headlamp

(76) Inventor: Christopher Lee Halasz, Parker, CO (US)

Correspondence Address: John R. Posthumus, Esq., LeBoeuf, Lamb, Greene & MacRae, L.L.P., Suite 2000, 633 Seventeenth Street, Denver, CO, 80202, US

(21) Appl. No.: 10/355,321

(22) Filed: Jan. 31, 2003

Related U.S. Application Data
(60) Provisional application No. 60/353,463, filed on Feb. 1, 2002.

(51) Int. Cl. B60Q 1/00

(52) U.S. Cl. 315/77; 315/82

(57) ABSTRACT

A headlamp includes a chamber or body for holding a power source, lens, a lens material, and one or more light emitting diodes. The construction and arrangement of the present invention provides, in part, for a substantially lower angle of illumination that facilitates viewing objects up close, adjustment of the light beam from spot to flood, and adjustment of the light illumination from the headlamp without requiring physical movement of the body of the headlamp relative to the wearer.

### RELATED APPLICATION

This application claims priority from U.S. Provisional Application No. 60/353,463, filed on Feb. 1, 2002, which is incorporated herein by reference.

### FIELD OF INVENTION

The present invention relates to the field of flashlights, and more specifically to an improved headlamp.

### BACKGROUND OF INVENTION

Illumination devices come in a variety of sizes, shapes and designs. Some are configured to allow the device to be placed on flat horizontal or vertical surfaces. Others are configured to allow the device to be placed on the head of a human being, as with headlamps.

Headlamps allow a wearer to illuminate an area in a forward direction hands free. In existing headlamps using incandescent light bulbs, variable focusing capability has required the use of reflectors. Unfortunately in LED headlamps, because the conical form of light LEDs emit, reflectors are not useful for this purpose. It would be desirable to have lens of varying powers to change the angle of light emitted by LEDs.

### SUMMARY OF INVENTION

The present invention satisfies, to a great extent, the foregoing and other needs not currently satisfied by existing headlamps. Accordingly, it is a feature and advantage of the present invention to provide an improved headlamp, which permits variation of the LED focusing. This is accomplished by causing the light emitted by the LEDs to pass through lenses of varying curvatures instead of varying the position of the illumination source within a reflector.

In the headlamp of the present invention, the LEDs are rotated in an arc behind a curved lens of varying dimensions. This allows the user to adjust the light beam upward for distance viewing, as well as downward when light is required to be directed closer to the wearer of the headlamp.

Preferably, the lower portion of the curved lens is planar, providing an additional benefit of the internal variable focus mechanism of the present invention; that is, permitting a wider beam for tasks closer at hand. The upper portion of the lens preferably contains different curvatures so as to focus the illumination emitted by the LEDs into a more intensely illuminated spot for distance viewing.

Another feature and advantage of the present invention provides a lower angle of illumination for viewing articles up close when the headlamp is positioned on the head of the wearer.

Another feature and advantage of the present invention provides an upper angle for viewing objects far away also.

Yet another feature and advantage of the present invention provides adjustment of the light illumination from the headlamp without requiring physical movement of the body of the headlamp relative to the wearer.

Another feature and advantage of the present invention provides for variable upward and downward adjustment of the illumination while permitting the headlamp to maintain a compact and low-profile aspect in all configurations.

Another feature and advantage of the present invention provides a headlamp that consumes less power.

Another feature and advantage of the present invention provides a headlamp that provides a longer illumination life.

Another feature and advantage of the present invention provides a headlamp that is inexpensive.

Another feature and advantage of the present invention provides a headlamp that is light in weight.

Additional features and advantages of the invention will become hereinafter apparent upon a reading of the following description of the preferred embodiments.

### BRIEF DESCRIPTION OF PREFERRED EMBODIMENTS

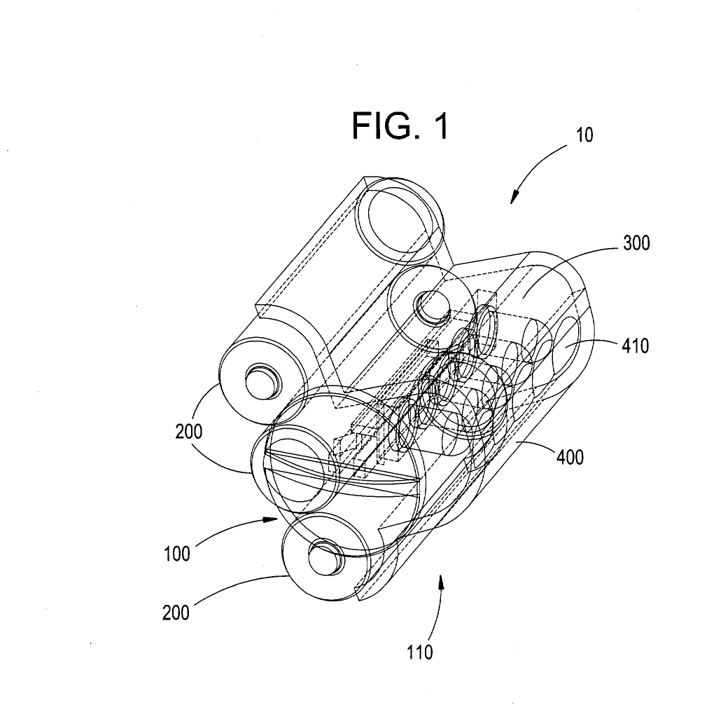

FIG. 1 is a perspective view of the headlamp in accordance with a preferred embodiment of the present invention.

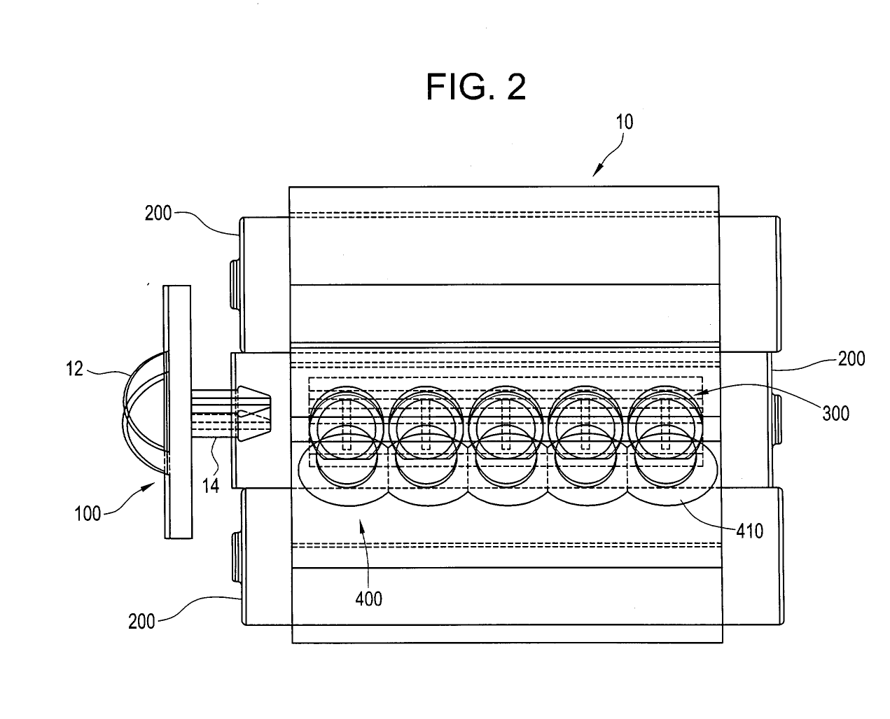

FIG. 2 is a front view of the headlamp of FIG. 1.

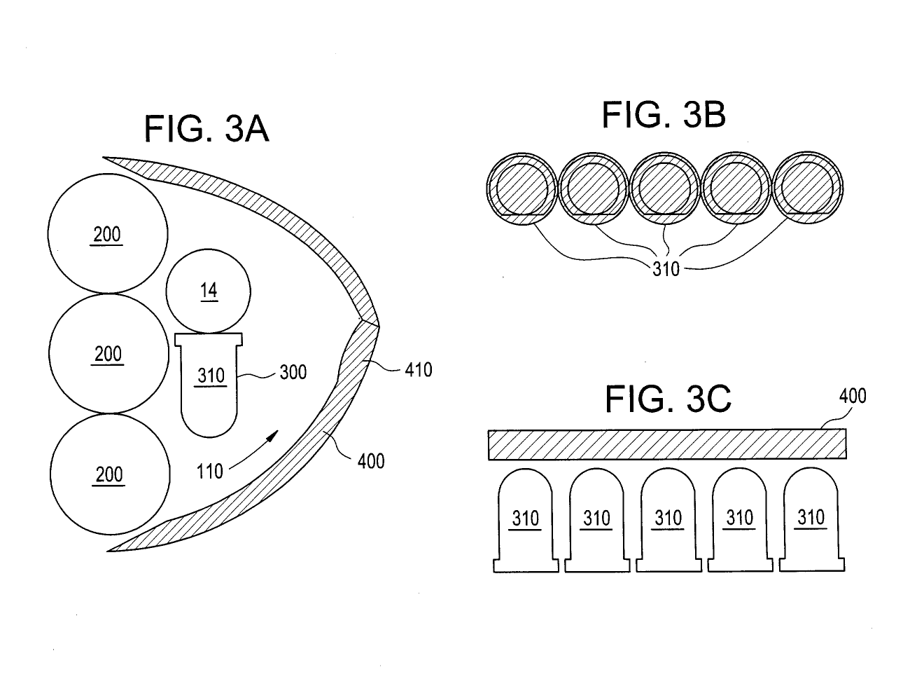

FIG. 3A is a side view of the lamps/lens arrangement in an “off” position.

FIG. 3B is a front view of the lamps of FIG. 3A.

FIG. 3C is a top view of the lamps and lens of FIG. 3A.

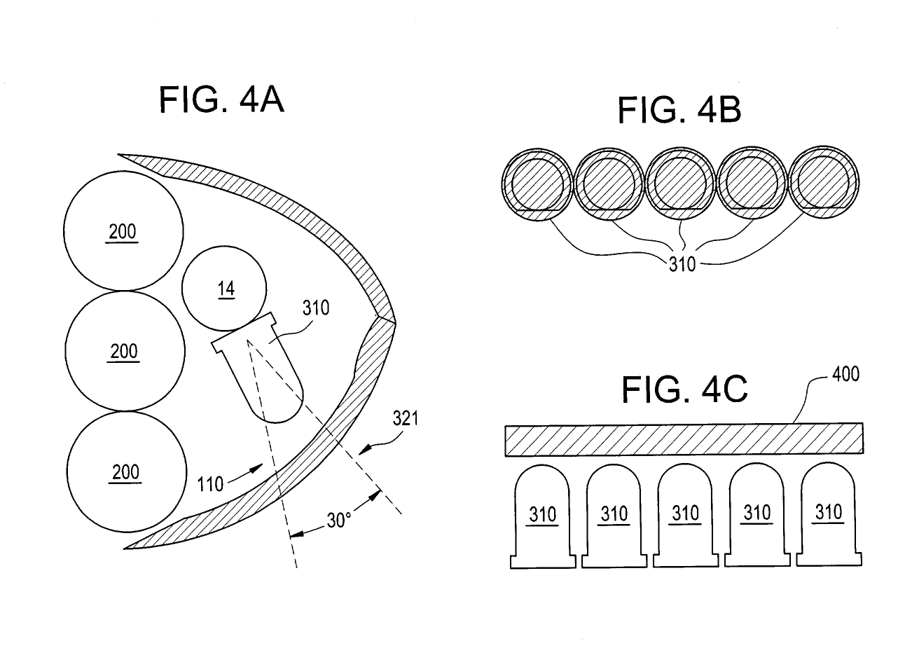

FIG. 4A is a side view of the lamps/lens arrangement when the headlamp is being turned on.

FIG. 4B is a front view of the lamps of FIG. 4A.

FIG. 4C is a top view of the lamps and lens of FIG. 4A.

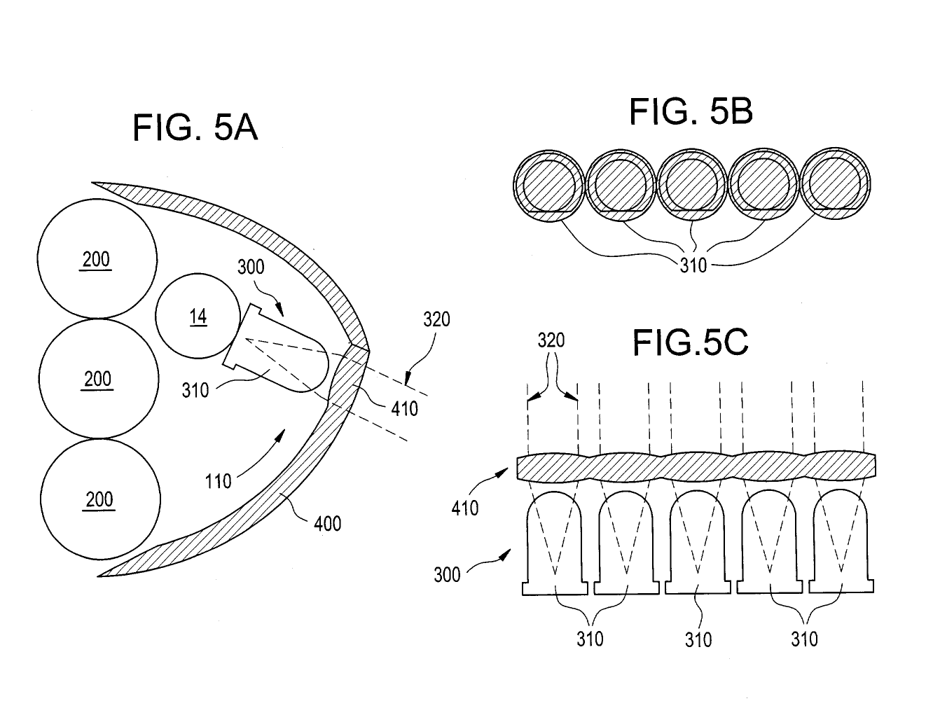

FIG. 5A is a side view of the lamps/lens arrangement in the “on” position.

FIG. 5B is a front view of the lamps of FIG. 5A.

FIG. 5C is a top view of the lamps and lens of FIG. 5A.

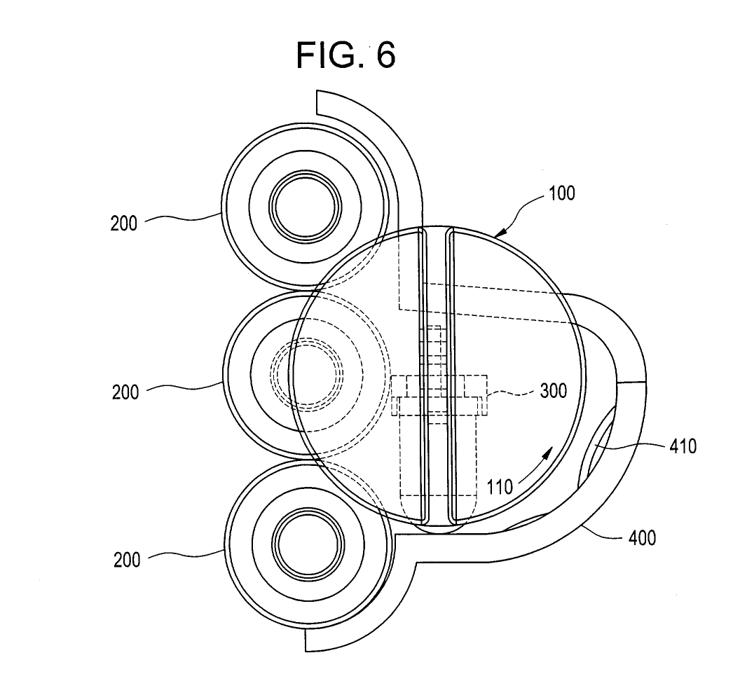

FIG. 6 is a side view of the headlamp of FIG. 1 in the “off” position.

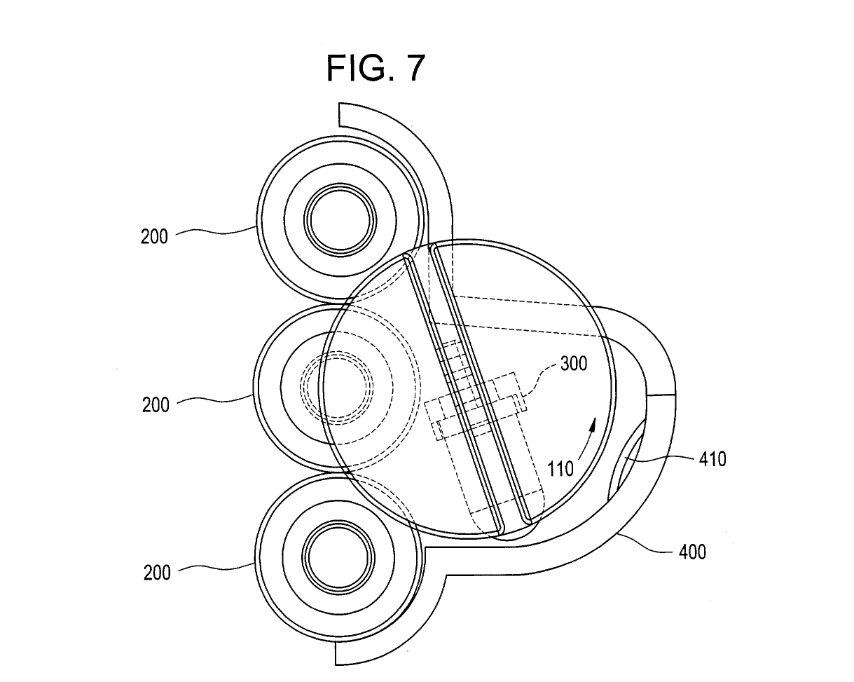

FIG. 7 is a side view of the headlamp of FIG. 1 being turned on.

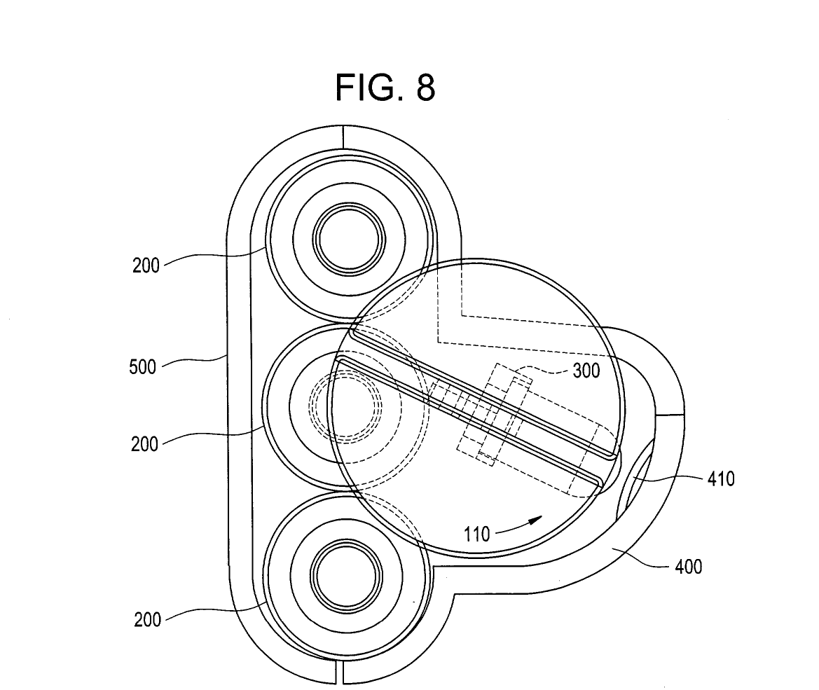

FIG. 8 is a side view of the headlamp of FIG. 1 in the “on” position.

### DETAILED DESCRIPTION OF PREFERRED EMBODIMENTS

Referring to FIG. 1, there is shown a headlamp 10 in accordance with one embodiment of the present invention. As depicted, the headlamp 10 includes a handle 100, a chamber or body for holding one or more batteries 200, lens material 400 and lens 410. The headlamp 10 includes a back 500 (FIG. 8) to enclose the power source or batteries 200, and a Light Emitting Diode (LED) grid 300.

A front view of the headlamp is shown in FIG. 2. The handle 100 is configured for rotational movement, preferably in a counter-clockwise direction. The handle 100 is shaped as a circular disc having an elongated strip 12, which stretches across its diameter and is connected to the disc at both ends, and having a rod 14.

The chamber, which is shown in FIG. 8 holding three batteries 200, is enclosed in a front portion by the lens material 400, and in a rear portion by the back 500. The interior portion of the chamber also houses the LED grid 300 and the lens 410. The lens 410 is positioned at a perimeter of the lens material 400. Preferably, the lens 410 consists of a durable synthetic material that efficiently transmits visible light.

In a preferred embodiment, the LED grid 300 employs multiple light emitting diodes. The diodes are electrically connected to the power source. As depicted, five LED lamps 310 are mounted on the grid, which is attached axially along a pivotable rod 14. One end of the rod 14 is attached to the handle 100, such that turning of the handle 100 translates into a rotational motion of the grid 310. The lamps 310 are shaped and orientable to direct light toward a target area. The lens 410 serves to direct light toward the target area also.

Referring now to FIGS. 3A, 3B and 3C, there is shown several views of the lamps 310 and lens 410 when the headlamp switch is in an “off” position. An alternative configuration of the lens material 400 is also shown.

Observe in FIG. 3A that the series of lamps 310 on the grid 300 is positioned away from the lens 410 when the switch is off. FIG. 3B shows the serial arrangement of the lamps 310 along the grid 300 behind the planar portion of the lower part of the lens 410. FIG. 3C shows the same arrangement from a viewpoint orthogonal to that in FIG. 3B.

Referring now to FIGS. 4A, 4B and 4C, there is shown several views of the lamps 310 and lens 410 when the headlamp switch enters the dispersed and adjustable range. For example, when the handle 100 of the headlamp 10 is rotated counter-clockwise, in the direction 110, it causes the grid 300 to rotate about rod 14 and turn on the lamps 310. At this point, as depicted, the light emitted from the lamps 310 is dispersed, as shown by rays 321. Preferably, the angle of dispersion ranges from approximately 15 degrees to approximately 30 degrees.

In FIG. 4A, the serial arrangement of the lamps 310 is in the middle position with respect to the lens material 400. In other words, FIG. 4A shows the lamps/lens arrangement when the headlamp 10 is being turned on with the LEDs in the lower configuration for close-up viewing. FIG. 4B shows the serial arrangement of the lamps 310 along the grid 300 behind the middle portion of the lens material 400, which, at this location, is substantially planar, thereby allowing relatively dispersed illumination. FIG. 4C shows the same arrangement from a viewpoint orthogonal to that in FIG. 4B.

Referring now to FIGS. 5A, 5B and 5C, there is shown several views of the lamps 310 and lens 410 when the headlamp switch is turned to the “on” position. In FIG. 5A, the serial arrangement of the lamps 310 is in an upper position with respect to the lens 410. When the handle 100 of the headlamp 10 is further rotated counter-clockwise, in the direction 110, it causes the grid 300 to further rotate about rod 14 and move into substantially direct alignment with lens 410. Such movement allows for the light emanating from the lamps 310 to be focused, as shown by rays 320, by positioning the lamps 310 at the focal point of the lens 410, or defocused by positioning the lamps 310 away from the focal point of the lens 410. In a preferred embodiment, the lens 410 may be positive, negative or any combination thereof.

FIG. 5B shows the serial arrangement of the lamps 310 along the grid 300 behind the upper portion of the lens material 410. FIG. 5C shows the same arrangement from a viewpoint orthogonal to that in FIG. 5B.

Referring now to FIG. 6, there is shown a side view of more details of the headlamp 10 in the “off” position, such as the handle 100 and the grid 300. Operation of the headlamp 10 is as previously discussed with reference to FIGS. 3A, 3B and 3C.

Referring now to FIG. 7, there is shown a side view of more details of the headlamp 10 being turned on. Operation of the headlamp 10 is as previously discussed with reference to FIGS. 4A, 4B and 4C. As the handle 100 is rotated in the direction 110, the lamps 310 mounted on the grid 300 turns on. As a result, light illuminating from the lamps 310 disperses through the lens material 400, which is preferably planar.

Referring now to FIG. 8, there is shown additional details of a side view of the headlamp 10 in the “on” position. Operation of the headlamp 10 is as previously discussed with reference to FIGS. 5A, 5B and 5C, such that further rotation of the handle 110 causes the lamps 310 in the grid 300 to move in substantial alignment with the lens 410. When the lamps 310 substantially align with the lens 410, the light illuminating from the lamps 310 is focused by the lens 410.

It is important to recognize that the construction and arrangement of the lamps 310, grid 300 and lens material 400 of the present invention, provides for a substantially lower angle of illumination and an appropriate focus of such illumination that facilitates viewing objects up close when the headlamp 10 is positioned on the head of the wearer. This is depicted in FIGS. 4A and 7. What is more, adjustment of the light illuminating from the headlamp 10 is effected by internal rotation of the grid 300 without requiring physical movement of the body of the headlamp 10 relative to the wearer.

The opposite also holds true. That is, the construction and arrangement of the lamps 310, grid 300 and lens material 400 of the present invention, provides for a substantially higher angle of illumination and improved focus that facilitates viewing objects far away when the headlamp 10 is positioned on the head of the wearer. This is accomplished when the lamps 310 project the flux through the lens 410. In addition, adjustment of the luminous flux from the headlamp 10 may be performed without requiring physical movement of the body of the headlamp 10 relative to the wearer.

It is yet a further advantage of the construction and arrangement of the present invention, that the headlamp 10 may be more easily substantially totally sealed or enclosed from the elements.

The foregoing description of the present invention has been presented for purposes of illustration and description. The description is not intended to limit the invention to the form disclosed herein. Consequently, the invention and modifications commensurate with the above teachings in skill and knowledge of the relevant art are within the scope of the present invention. It is intended that the foregoing description be construed to include all alternative embodiments as permitted by the prior art.

What is claimed is:

1. A headlamp comprising:
(a) a plurality of light emitting diodes arranged for directing light toward a target area by rotational movement within a body of said headlamp without requiring movement of said body relative to a wearer of said headlamp;
(b) a power source for providing power to said plurality of light emitting diodes; and
(c) one or more lens variably positioned with respect to said plurality of light emitting diodes so as to cause variability of focusing.

2. The headlamp according to claim 1, wherein an adjustment of light illumination from said headlamp does not require movement of the body of said headlamp relative to a wearer of said headlamp.

3. The headlamp according to claim 1, wherein adjustment of illumination from said headlamp is caused by rotation of said plurality of light emitting diodes with respect to said one or more lens.

4. The headlamp according to claim 1, wherein said one or more lens is planar.

5. The headlamp according to claim 1, wherein said one or more lens is positive.

6. The headlamp according to claim 1, wherein said one or more lens is negative.

7. A headlamp comprising:
(a) a plurality of light emitting diodes arranged for directing light toward a target area by rotational movement within a body of said headlamp without requiring movement of said body relative to a wearer of said headlamp;
(b) a power source for providing power to said plurality of light emitting diodes; and
(c) one or more lens variably positioned with respect to said plurality of light emitting diodes so as to cause repositioning of light beam upwards and downwards.
